(19) United States
(12) Patent Application Publication
(10) Pub. No.: US 2024/0137734 A1
(43) Pub. Date: Apr. 25, 2024

(54) PWS SUPPORT FOR UE TO NETWORK RELAY ON CELLULAR NETWORK SYSTEM

(71) Applicant: QUALCOMM Incorporated, San Diego, CA (US)

(72) Inventors: Sunghoon KIM, San Diego, CA (US); Hong CHENG, Basking Ridge, NJ (US); Lenaig Genevieve CHAPONNIERE, La Jolla, CA (US); Peng CHENG, Beijing (CN)

(21) Appl. No.: 18/547,500

(22) PCT Filed: Apr. 5, 2021
(86) PCT No.: PCT/CN2021/085640

§ 371 Date: Aug. 21, 2023

(51) Int. Cl. H04W 4/12; H04W 4/90; H04W 8/00

(52) U.S. Cl. CPC H04W 4/12; H04W 4/90; H04W 8/005; H04W 92/18

(57) ABSTRACT

Aspects of the present disclosure relate to wireless communications, and more particularly, to techniques for relaying public warning system (PWS) messages to a remote user equipment (UE) via a relay UE.

### FIELD OF THE DISCLOSURE

Aspects of the present disclosure relate to wireless communications, and more particularly, to techniques for relaying public warning system (PWS) messages to a remote user equipment (UE) via a relay UE.

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

Sidelink communications are communications from one UE to another UE. As the demand for mobile broadband access continues to increase, there exists a need for further improvements in NR and LTE technology, including improvements to sidelink communications. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description” one will understand how the features of this disclosure provide advantages that include improved communications between access points and stations in a wireless network.

Certain aspects provide a method for wireless communication by a relay user equipment (UE). The method generally includes receiving a broadcast public warning system (PWS) message and forwarding the PWS message to at least one remote UE via a sidelink interface.

Certain aspects provide a method for wireless communication by a remote user equipment (UE). The method generally includes receiving a broadcast public warning system (PWS) message forwarded by a relay UE via a sidelink interface and forwarding the PWS message to a PWS component of the remote UE.

Certain aspects provide a method for wireless communication by a network entity. The method generally includes receiving, from a relay UE, a first message with data and an indication the data is from a remote UE, determining, based on the indication provided with the first message, that the data is from the remote UE, and processing the data.

Aspects generally include methods, apparatus, systems, computer readable mediums, and processing systems, as substantially described herein with reference to and as illustrated by the accompanying drawings.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIG. 5 is a high level path diagram illustrating example connection paths of a remote user equipment (UE), in accordance with certain aspects of the present disclosure.

FIG. 6 is a high level path diagram illustrating example delivery of a public warning system (PWS) message to a user equipment (UE).

FIG. 7 is a flow diagram illustrating example operations that may be performed by a relay UE, in accordance with certain aspects of the present disclosure.

FIG. 8 is a flow diagram illustrating example operations that may be performed by a remote UE, in accordance with certain aspects of the present disclosure.

FIGS. 9A and 9B illustrate a first example of relaying of a public warning system (PWS) message to a user equipment (UE), in accordance with certain aspects of the present disclosure.

FIGS. 10A and 10B illustrate a second example of relaying of a public warning system (PWS) message to a user equipment (UE), in accordance with certain aspects of the present disclosure.

FIGS. 11A and 11B illustrate a third example of relaying of a public warning system (PWS) message to a user equipment (UE), in accordance with certain aspects of the present disclosure.

FIGS. 12A and 12B illustrating a fourth example of relaying of a public warning system (PWS) message to a user equipment (UE), in accordance with certain aspects of the present disclosure.

FIG. 13 illustrates a communications device that may include various components configured to perform the operations illustrated in FIG. 7, in accordance with certain aspects of the present disclosure.

FIG. 14 illustrates a communications device that may include various components configured to perform the operations illustrated in FIG. 8, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to techniques for relaying public warning system (PWS) messages to a remote user equipment (UE) via a relay UE.

The connection between the relay and the network entity, may be called a Uu connection or via a Uu path. The connection between the remote UE and the relay (e.g., another UE or a “relay UE”), may be called a PC5 connection or via a PC5 path. The PC5 connection is a device-to-device connection that may take advantage of the comparative proximity between the remote UE and the relay UE (e.g., when the remote UE is closer to the relay UE than to the closest base station). The relay UE may connect to an infrastructure node (e.g., gNB) via a Uu connection and relay the Uu connection to the remote UE through the PC5 connection.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. Cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). Cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

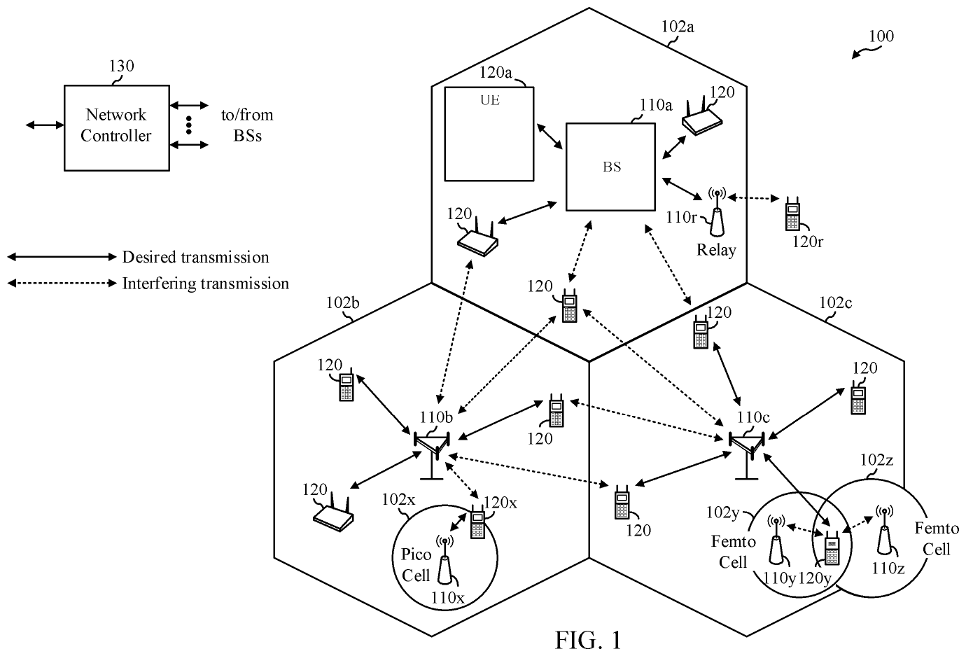

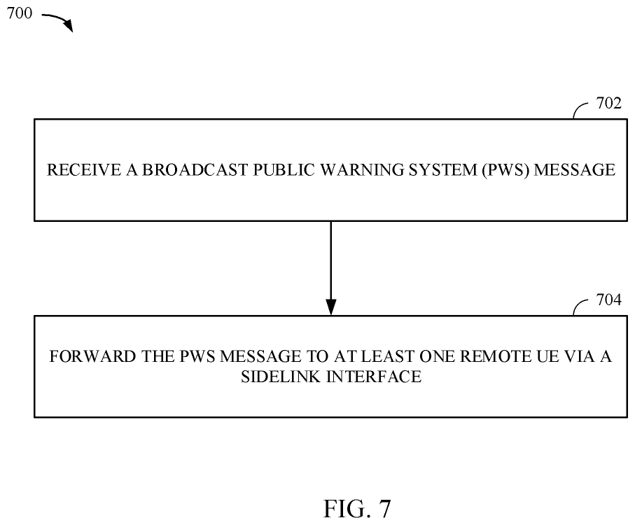

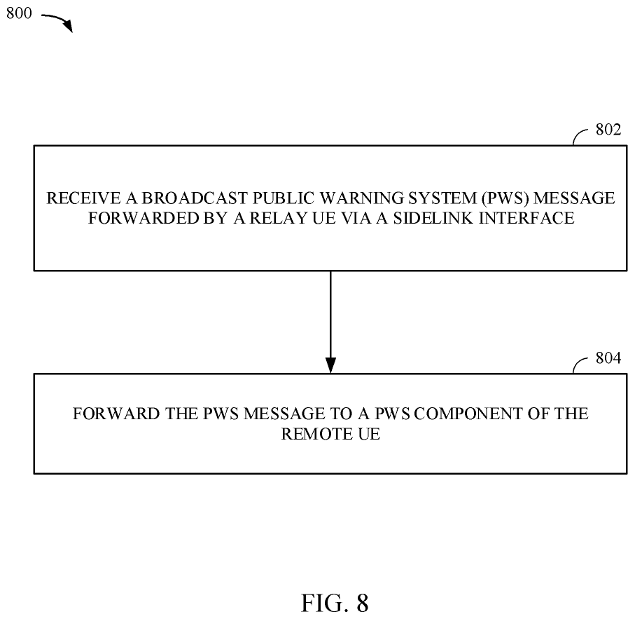

FIG. 1 illustrates an example wireless communication network 100 in which aspects of the present disclosure may be performed. For example, UEs 120a may be configured to perform operations 700 described below with reference to FIG. 7 and/or operations 800 described below with reference to FIG. 8.

As illustrated in FIG. 1, the wireless communication network 100 may include a number of base stations (BSs) 110a-z (each also individually referred to herein as BS 110 or collectively as BSs 110) and other network entities. In aspects of the present disclosure, a roadside service unit (RSU) may be considered a type of BS, and a BS 110 may be referred to as an RSU. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

Wireless communication network 100 may also include relay UEs (e.g., relay UE 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

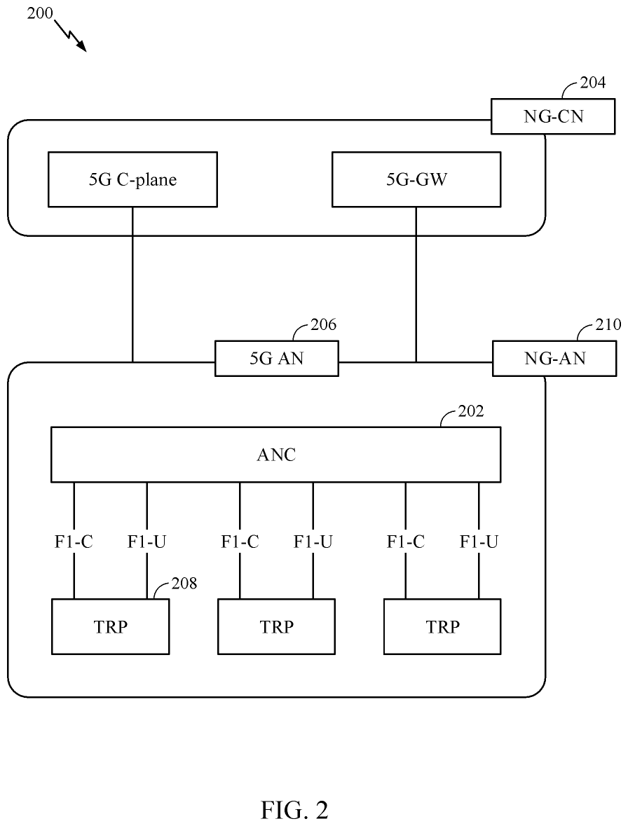

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

Logical functions may be dynamically distributed in the logical architecture of distributed RAN 200. The Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

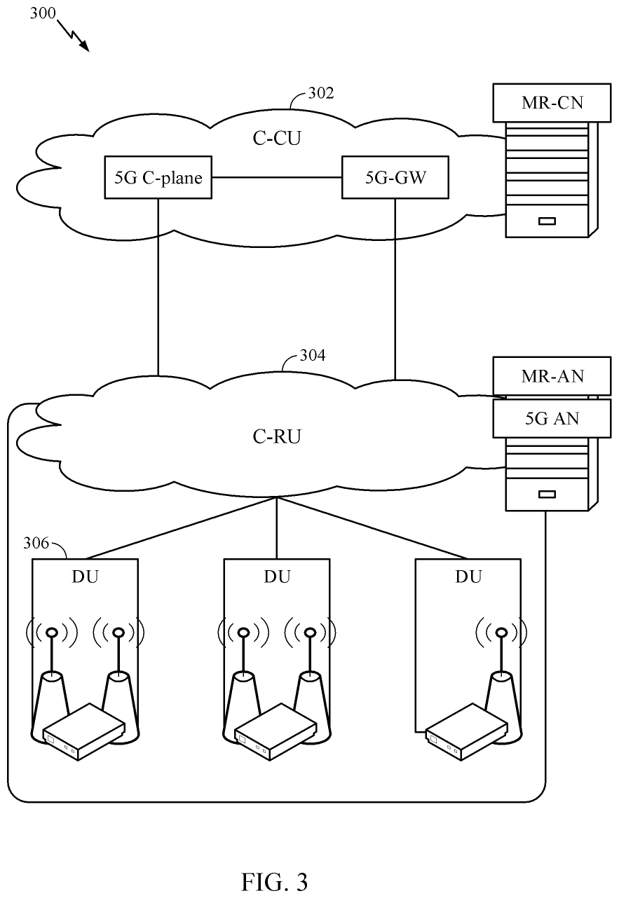

FIG. 3 illustrates an example physical architecture of a distributed RAN 300, according to aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

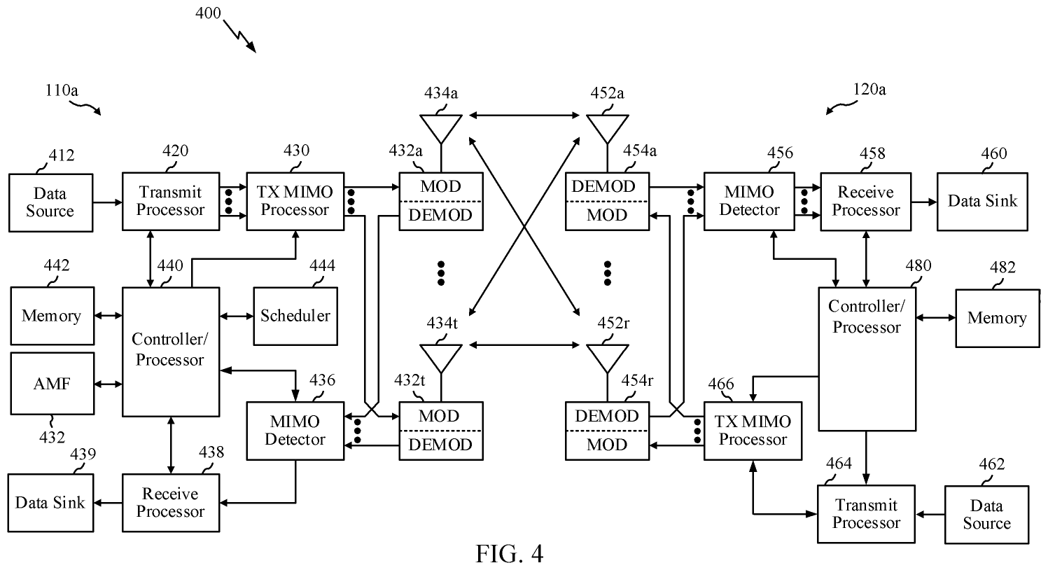

FIG. 4 illustrates example components of BS 110a and UE 120a (as depicted in FIG. 1), which may be used to implement aspects of the present disclosure. For example, antennas 452, processors 466, 458, 464, and/or controller/processor 480 of the UE 120a and/or antennas 434, processors 420, 430, 438, and/or controller/processor 440 of the BS 110a may be used to perform the various techniques and methods described herein with reference to FIGS. 15, 16, and 17.

At the BS 110a, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120a, the antennas 452a through 452r may receive the downlink signals from the base station 110a and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120a to a data sink 460, and provide decoded control information to a controller/processor 480.

On the uplink, at UE 120a, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the base station 110a. At the BS 110a, the uplink signals from the UE 120a may be received by the antennas 434, processed by the modulators 432, detected by a MIMO detector 436 if applicable, and further processed by a receive processor 438 to obtain decoded data and control information sent by the UE 120a. The receive processor 438 may provide the decoded data to a data sink 439 and the decoded control information to the controller/processor 440.

The controllers/processors 440 and 480 may direct the operation at the BS 110a and the UE 120a, respectively. The processor 440 and/or other processors and modules at the BS 110a may perform or direct the execution of processes for the techniques described herein with reference to FIGS. 15, 16, and 17.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks (WLANs), which typically use an unlicensed spectrum).

### Example UE to NW Relay

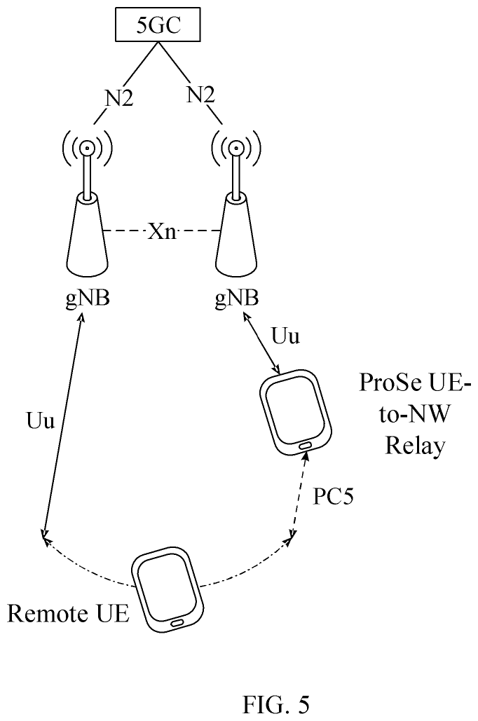

Aspects of the present disclosure involves a remote UE, a relay UE, and a network, as shown in FIG. 5, which is a high level path diagram illustrating example connection paths: a Uu path (cellular link) between a relay UE and the network gNB, a PC5 path (D2D link) between the remote UE and the relay UE. The remote UE and the relay UE may be in radio resource control (RRC) connected mode.

As illustrated, the relay UE may utilize a Proximity Services (ProSe) component to communicate with the Remote UE. ProSe generally refers to a D2D (Device-to-Device) technology that allows devices to detect each other and to communicate directly. ProSe utilizes enhancements to existing standards, such as the PC5 “sidelink” air interface for direct connectivity between devices.

ProSe may offer various benefits, such as scalability, manageability, privacy, security, and battery life. As will be described herein, a ProSe layer may also play a role in the public safety and critical communications sector, by relaying public warning service (PWS) messages to remote UEs that might not be reachable by conventional PWS delivery mechanisms.

A remote UE may generally connect to a relay UE via a layer 3 (L3) connection with no Uu connection with (and no visibility to) the network or via a layer 2 (L2) connection where the UE supports Uu access stratum (AS) and non-AS connections (NAS) with the network.

When there is no direct connection path (Uu connection) between the remote UE and the network node. In this situation, the remote UE does not have a Uu connection with a network and is connected to the relay UE via PC5 connection only (e.g., Layer 3 UE-to-NW). The PC5 unicast link setup may, in some implementations, be needed for the relay UE to serve the remote UE. The remote UE may not have a Uu application server (AS) connection with a radio access network (RAN) over the relay path. In other cases, the remote UE may not have direct none access stratum (NAS) connection with a 5G core network (5GC). The relay UE may report to the 5GC about the remote UE's presence. Alternatively and optionally, the remote UE may be visible to the 5GC via a non-3GPP interworking function (N3IWF).

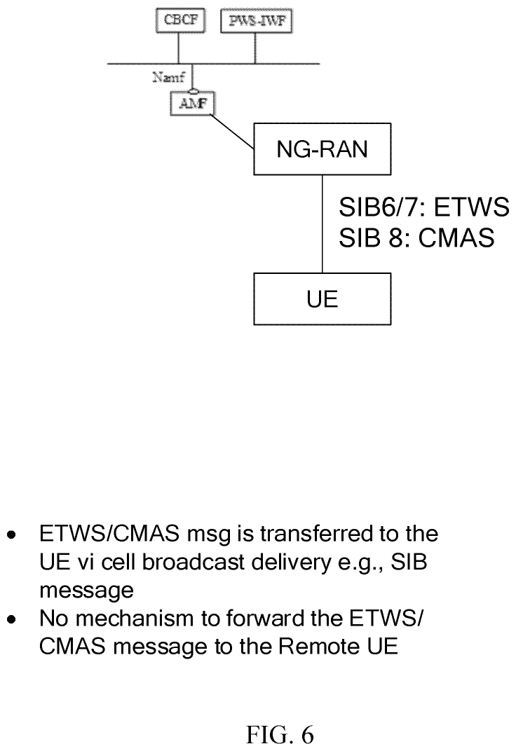

When there is direct connection path between the remote UE and the network node. This control plane protocol stack refers to an L2 relay option based on NR-V2X connectivity. Both PC5 control plane (C-plane) and the NR Uu C-plane are on the remote UE, similar to what is illustrated in FIG. 6. The PC5 C-plane may set up the unicast link before relaying. The remote UE may support the NR Uu AS and NAS connections above the PC5 radio link control (RLC). The NG-RAN may control the remote UE's PC5 link via NR radio resource control (RRC). In some embodiments, an adaptation layer may be needed to support multiplexing multiple UEs traffic on the relay UE's Uu connections.

Certain systems, such as NR, may support standalone (SA) capability for sidelink-based UE-to-network and UE-to-UE relay communications, for example, utilizing layer-3 (L3) and layer-2 (L2) relays, as noted above.

Particular relay procedures may depend on whether a relay is a L3 or L2 relay. In some cases, a remote UE establishes PC5-S unicast link setup and obtains an IP address. The PC5 unicast link AS configuration is managed using PC5-RRC. The relay UE and remote UE coordinate on the AS configuration. The relay UE may consider information from RAN to configure PC5 link. Authentication/authorization of the remote UE access to relaying may be done during PC5 link establishment.

Discovery for both relay selection and reselection may be supported. Different type of discovery models may be supported. For example, according to a first model (referred to as Model A discovery) a UE sends discovery messages (an announcement) while other UEs monitor. According to a second model (referred to as Model B discovery), a UE (discoverer) sends a solicitation message and waits for responses from monitoring UEs (discoverees). Such discovery messages may be sent on a PC5 communication channel (e.g., and not on separate discovery channel). Discovery messages may be carried within the same layer-2 frames as those used for other direct communication including, for example, the Destination Layer-2 ID that can be set to a unicast, groupcast or broadcast identifier, the Source Layer-2 ID that is always set to a unicast identifier of the transmitter, and the frame type indicates that it is a ProSe Direct Discovery message.

For relay selection, the remote UE has not connected to any relay node (i.e. PC5 unicast link is not established between remote UE and relay node). In this case, it may be desirable to design DRX modes to reduce remote UE power consumption on monitoring relay discovery messages for relay selection.

As noted above, for relay reselection, the remote UE has connected to at least one relay node (e.g., with a PC5 unicast established between the emote UE and relay node). For relay reselection, it may be desirable to design a DRX configuration that helps reduce remote UE power consumption while monitoring for relay discovery messages for relay reselection and PC5 data transmission.

### Example Public Warning System Message Delivery

Public warning system (PWS) messages are generally designed to alert and inform citizens that are threatened by a hazard. The PWS messages may include information with the purpose of enabling those citizens to prepare and to act in a timely manner to reduce the impact of the hazard.

Typical use cases for a Public Warning System (PWS) include sending warning messages related to natural disasters such as earthquakes, tsunamis or severe storms, or ongoing criminal actions like child abductions or terrorist actions. It can also be used for example to transmit road traffic conditions. Examples of PWS messages include earthquake and Tsunami Warning Systems (ETWS) messages and Commercial Mobile Alert Systems (CMAS) messages.

FIG. 6 is a high level path diagram illustrating conventional delivery of a PWS to a user equipment (UE), for example, in a 5G architecture. As illustrated, PWS support in the 5G architecture relies on a Cell Broadcast Centre Function (CBCF), which has the ability to work with a PWS-Inter Working Function (IWF) to trigger the radio network to transmit one single short message to multiple devices in the network simultaneously. The PWS messages may be broadcast either within the whole network or within certain geographical areas.

A PWS message request is sent from the CBCF to the applicable access and mobility functions (AMFs), which sends a corresponding request to all (NG-RAN) base stations within the requested geographical area. The AMF may also report back to the CBCF if the transmission was successful or not, for example, based on reports received from the radio network.

PWS capable UEs (PWS-UE) in idle mode are typically required to be capable of receiving broadcasted Warning Notifications. As noted above, such notices are typically broadcast to a Notification Area which is based on the geographical information as specified by the Warning Notification Provider. ETWS or CMAS capable UEs in RRC IDLE or in RRC INACTIVE are typically required to monitor for indications about PWS notification in its own paging occasion every discontinuous reception (DRX) cycle. ETWS or CMAS capable UEs in RRC CONNECTED are typically required to monitor for indication about PWS notification in any paging occasion at least once every defaultPagingCycle if the UE is provided with common search space on the active BWP to monitor paging.

Unfortunately, there is typically no mechanism to forward to PWS messages to a remote UE. Thus, if a UE is out of coverage (OOC) of the cellular network, that UE may miss out on PWS messages.

### PWS SUPPORT FOR UE TO CELLULAR NETWORK RELAY

Aspects of the present disclosure utilize a relay UE to deliver PWS messages to remote UEs that might not be reachable by conventional PWS delivery mechanisms. As will be described in greater detail below, the present disclosure solutions for forwarding PWS messages to a remote UE through a relay UE.

FIG. 7 illustrates example operations that may be performed by a relay UE. For example, operations 700 may be performed by a relay UE of FIG. 1 or FIG. 5 to relay PWS messages to a remote UE, in accordance with aspects of the present disclosure.

Operations 700 begin, at 702, by receiving a broadcast public warning system (PWS) message. For example, the PWS message may be received in a broadcast system information block (SIB), such as SIB6/7 or SIB 8.

At 704, the relay UE forwards the PWS message to at least one remote UE via a sidelink interface. For example, the PWS message may be forwarded via a new (e.g., dedicated) sidelink message or an existing sidelink message. In some cases, a SIB including the PWS message may be forwarded.

FIG. 8 illustrates example operations that may be performed by a remote UE and may be considered complementary to operations 700 of FIG. 7. For example, operations 700 may be performed by a remote UE of FIG. 1 or FIG. 5 to receive and process PWS messages forwarded by a relay UE performing operations 700 of FIG. 7.

Operations 800 begin, at 802, by receiving a broadcast public warning system (PWS) message forwarded by a relay UE via a sidelink interface. As noted above, the PWS message may be received via a new or existing sidelink message, separately, or in a SIB including the PWS message.

At 804, the remote UE forwards the PWS message to a PWS component of the remote UE. The remote UE/PWS component may then process the PWS message (e.g., by triggering a visual/audible alert/notification on the remote UE).

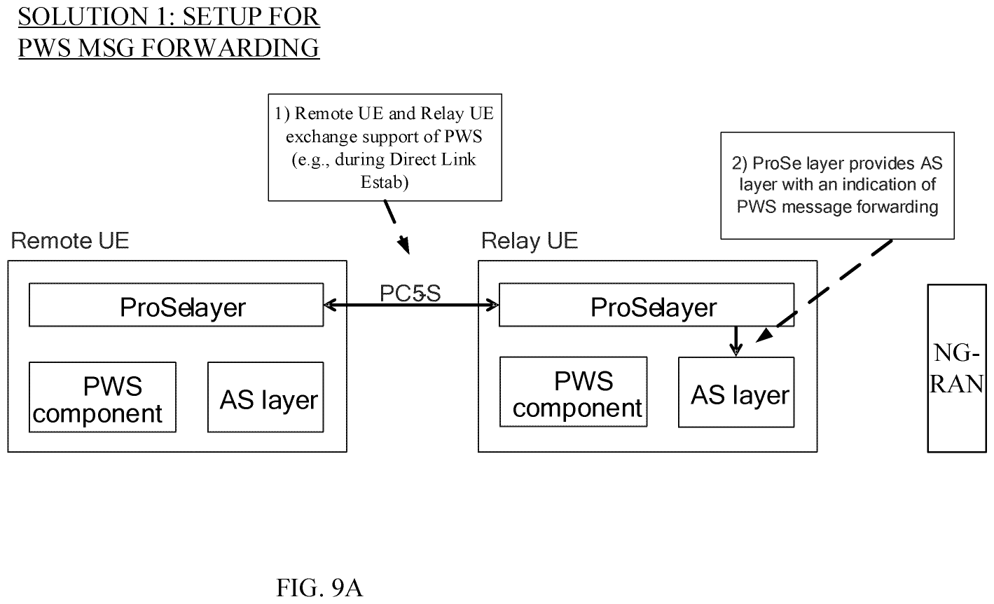

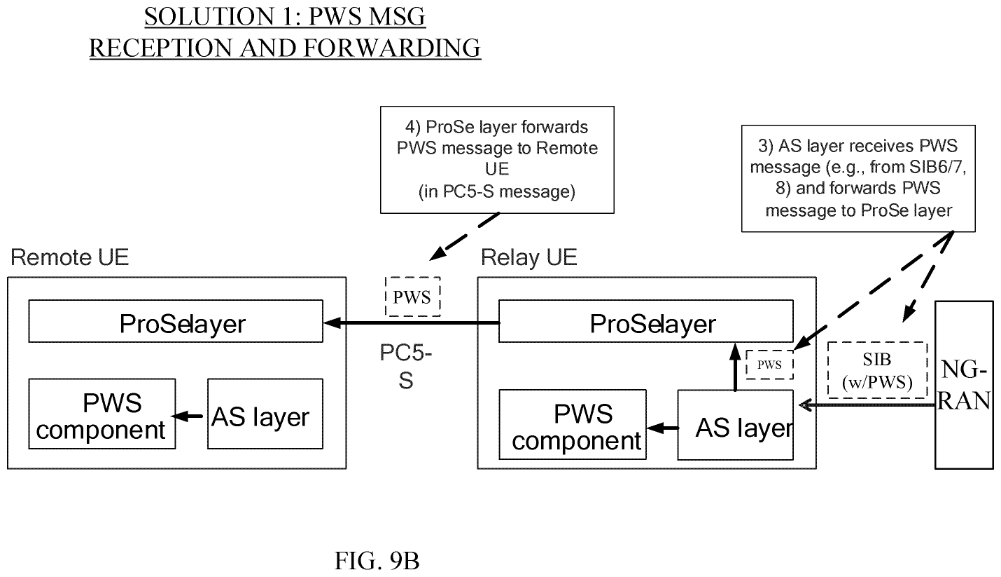

Operations of FIGS. 7-8 may be understood with reference to the diagrams shown in FIGS. 9-12, which illustrate different examples of relaying of PWS message to a remote UE, in accordance with certain aspects of the present disclosure.

FIGS. 9A and 9B illustrate an example of relaying of PWS message to a remote UE via PWS message forwarding via ProSe layer.

FIG. 9A illustrates configuration of the relay UE for ProSe layer forwarding of PWS messages. As illustrated (at step 1), the remote UE and relay UE may exchange information regarding their support of PWS, for example, during a Direct Link Establishment procedure. In some cases, if a relay UE is not enabled for PWS, the remote UE may reject the direct link establishment. In some cases, the remote UE may indicate its support of PWS (e.g., PWS-enabled) during a Direct Discovery procedure (e.g., a stand-alone procedure where the UE may discover the peer and may further decide whether to establish direct link).

After learning of the remote UE PWS support (via Direct Link Establishment, Direct Discovery, or pre-configuration) the relay UE may prepare to forward PWS messages to the remote UE. For example, as illustrated at step 2, the ProSe layer of Relay UE provides AS layer with an indication of PWS message forwarding, such that the AS layer is configured to forward PWS messages. In some cases, the relay UE may be configured to forwards all received PWS messages to the remote UE (without any filtering based on e.g., geo-location).

As illustrated in FIG. 9B, once Relay UE's AS layer receives PWS message from SIB(6/7, 8), at step 3, the AS layer forwards the PWS message to ProSe layer. The ProSe layer may determine the intended target Remote UE(s) to send the PWS message to (e.g., via an L2 ID, Unicast Link ID, etc.). In some cases, the ProSe layer may decide to use groupcast if multiple remote UE(s) exist or if it is so configured. In some cases, an L2 ID may be pre-defined for PWS and/or an L2 groupcast ID may be signaled during the PC5 link establishment or a PC5 link modification procedure. In such cases, the relay UE may inform remote UEs of L2 groupcast ID for PWS forwarding.

As shown, at step 4, the ProSe layer of the relay UE may forward the PWS message to the remote UE. In some cases, the ProSe layer may generate a PC5-S message and includes the PWS message received from the AS layer. In some cases, the ProSe layer may use a new (e.g., dedicated) PC5-S message to forward the PWS message (e.g., a Direct PWS Forwarding Request message). In other cases, the ProSe layer may use an existing PC5-S message (e.g., a Direct Link Update procedure or Relay Discovery Additional information message) to forward the PWS message, with an indication the message is for PWS forwarding.

The ProSe layer may use a PC5 groupcast with the L2 groupcast ID. The ProSe layer of the remote UE may receive the PWS message and, in some cases, may send a response to the Relay UE (e.g., in case the PWS message was forwarded via a unicast message). As noted above, the ProSe layer of the remote UE may forward the PWS message received from the relay UE to the PWS component.

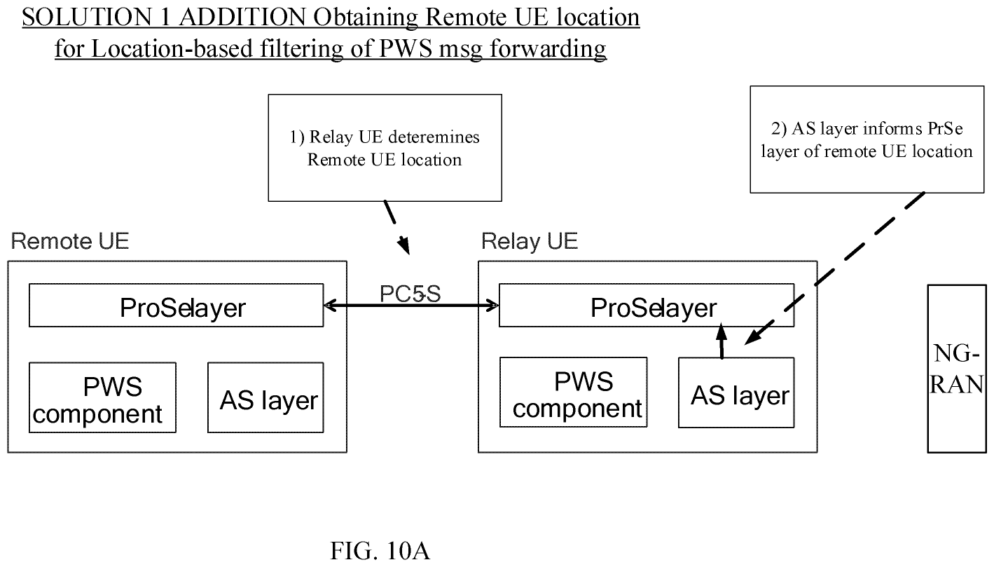

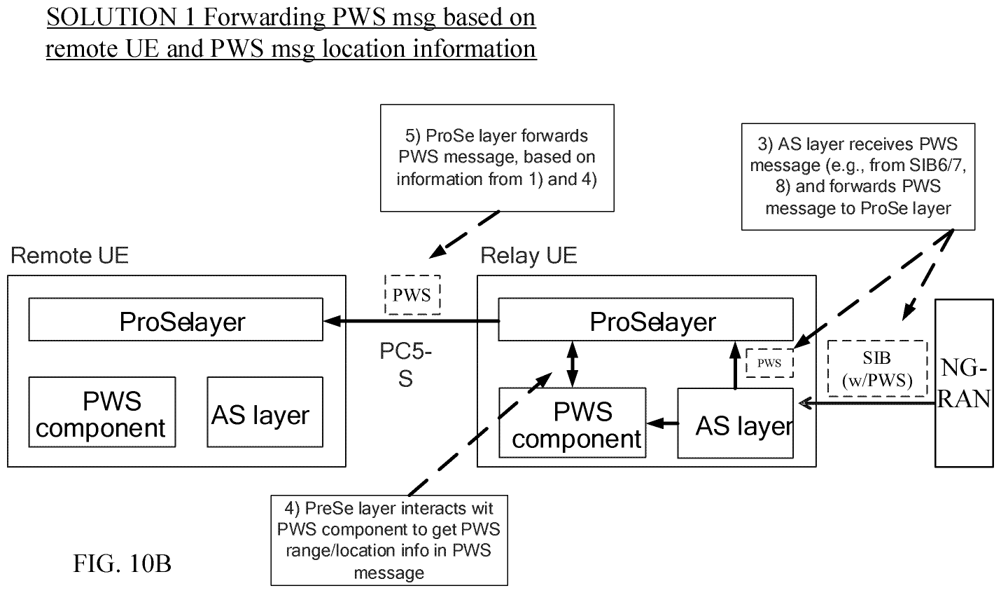

As illustrated in FIGS. 10A and 10B, in some cases, location-based filtering may be applied by the relay UE when performing PWS message forwarding.

As illustrated in FIG. 10A, at step 1, the relay UE can determine remote UE's location based on relevant information. For example, a SL Range for the PC5 unicast link may be negotiated during the PC5 unicast link establishment or PC5 unicast link modification. In some cases, at step 2, the AS layer informs ProSe layer of how far the Remote UE is located based on the link management information over PC5-RRC (RSRP).

As illustrated in FIG. 10B, after the relay UE receives a PWS message (and forwards a copy of the PWS message to the PWS component), at step 3, the ProSe layer may interact with the PWS component to get the location information in the PWS message (e.g., via an IE: Warning Area Coordinates), at step 4.

At step 5, based on the remote UE and PWS location information (from step 1 and step 4), the relay UE can determine whether or not to forward the PWS message to the remote UE. In other words, the PWS message can be location specific, so the relay UE may only forward the PWS message to the remote UE if it is located within the location where the PWS message is to be sent.

In case of multi-hop relaying (e.g., Remote UE—Relay UE—Relay UE—NG-RAN), it may be more likely that a UE in an irrelevant area inadvertently receives a relayed PWS message. With the location-based filtering proposed herein, however, a relay UE can determine whether the remote UE is in a valid area for the PWS message and only forward to relevant remote UEs.

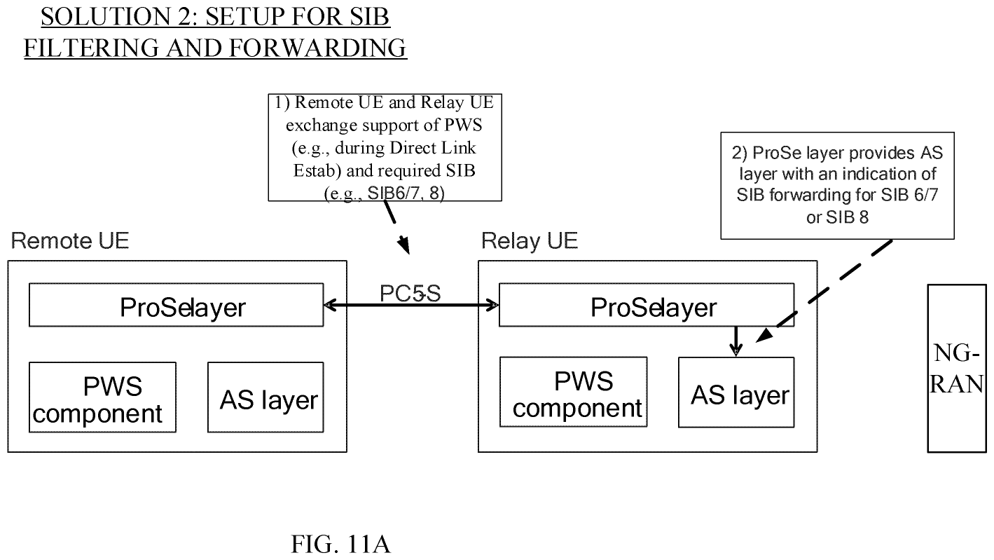

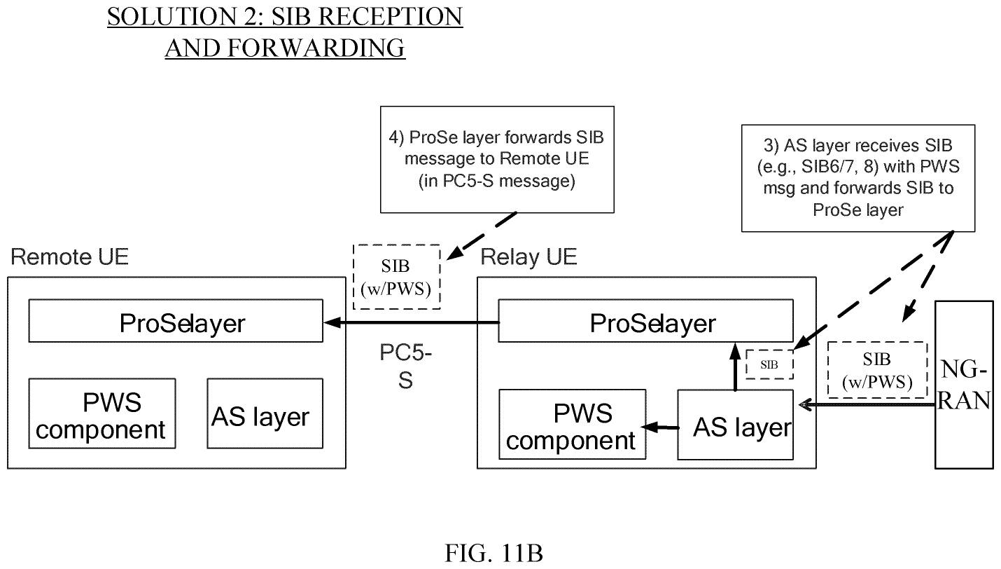

FIGS. 11A and 11B illustrate an example of relaying of PWS message to a remote UE via SIB filtering and forwarding via the ProSe layer.

As illustrated in FIG. 11A (at step 1), the remote UE and relay UE may exchange information regarding their support of PWS, for example, during a Direct Link Establishment procedure or Direct Discovery procedure.

In some cases, the remote UE may provide an indication of required SIB (SIB6/7 or SIB8) during the Direct Link establishment procedure or Direct Link Update procedure. As shown as step 2, the ProSe layer may provide the AS layer with an indication of SIB forwarding (for SIB 6/7 or SIB 8). The Relay UE may store an indication of which SIB is to be forwarded (e.g., SIB6/7 or SIB8) in a Remote UE context maintained at the relay UE.

As illustrated in FIG. 11B, once Relay UE's AS layer receives a SIB (6/7, 8) including a PWS message, at step 3, the AS layer forwards the (whole) SIB to ProSe layer. If the AS layer is not informed on which SIBs to forward, it may blindly forward all updated SIBs to the ProSe layer.

The ProSe layer may determine the intended target Remote UE(s) to send the SIB message to (e.g., via an L2 ID, Unicast Link ID, etc.) for example, based on the remote UE context. As noted above, the ProSe layer may decide to use groupcast if multiple remote UE(s) exist or if it is so configured. In some cases, an L2 ID may be pre-defined for SIB forwarding and/or an L2 groupcast ID may be signaled during the PC5 link establishment or a PC5 link modification procedure. In such cases, the relay UE may inform remote UEs of L2 groupcast ID for SIB forwarding.

As shown, at step 4, the ProSe layer of the relay UE may forward the SIB message to the remote UE. In some cases, the ProSe layer may generate a PC5-S message and includes the SIB message received from the AS layer. In some cases, the ProSe layer may use a new (e.g., dedicated) PC5-S message to forward the SIB message (e.g., a Direct PWS Forwarding Request message). In other cases, the ProSe layer may use an existing PC5-S message (e.g., a Direct Link Update procedure or Relay Discovery Additional information message) to forward the SIB message, with an indication the message is for SIB forwarding.

The ProSe layer may use a PC5 groupcast with the L2 groupcast ID. The ProSe layer of the remote UE may receive the SIB message and, in some cases, may send a response to the Relay UE (e.g., in case the SIB message was forwarded via a unicast message). The ProSe layer of the remote UE may forward the SIB message received from the relay UE to the AS layer. The AS layer may then forwards the PWS message in the SIB to the PWS component.

The techniques described above, for PWS message forwarding via a ProSe Layer and SIB filtering and forwarding via ProSe Layer may have various benefits. The difference between the two solutions is mainly whether to forward specific PWS messages or SIB messages themselves. There may be no major AS layer impact to forward either PWS messages or SIB messages. The ProSe layer may determine whether the remote UE requires a PWS/SIBx during the existing PC5 link procedure. The ProSe layer may also manage the Remote UE context to determine the target Remote UE (L2 ID) when forwarding is needed. The ProSe layer may also generate the message for PWS message/SIB message forwarding.

The techniques presented may allow for relatively resource efficient PWS/SIB forwarding via PC5 groupcast. In other words, if there are multiple Remote UE(s) to the Relay UE, groupcast may be more efficient to forward the same PWS message to multiple target Remote UE(s).

Another potential benefit is that only necessary information may be forwarded. In other words, the relay UE does not have to forward all SIB messages to the Remote UE, which is resource efficient.

In addition, a remote UE does not have to wake up to receive unnecessary SIB messages. For example, the remote UE may receive the SIB or PWS messages via the Relay UE only if necessary, as determined by the ProSe layer. This may allow the remote UE to keep following power saving mechanism (e.g., PC5-DRX cycle).

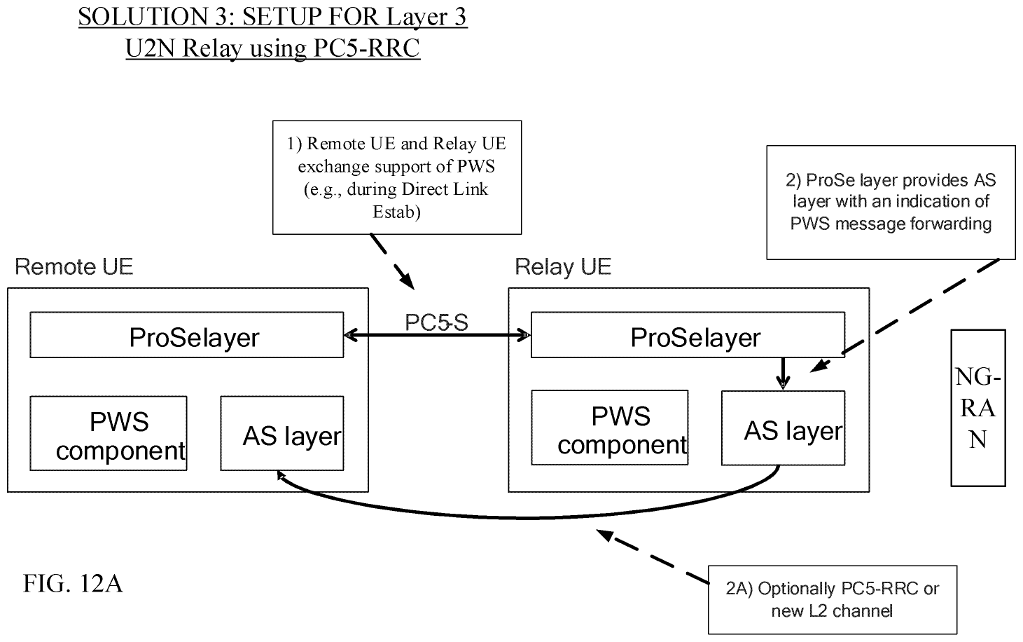

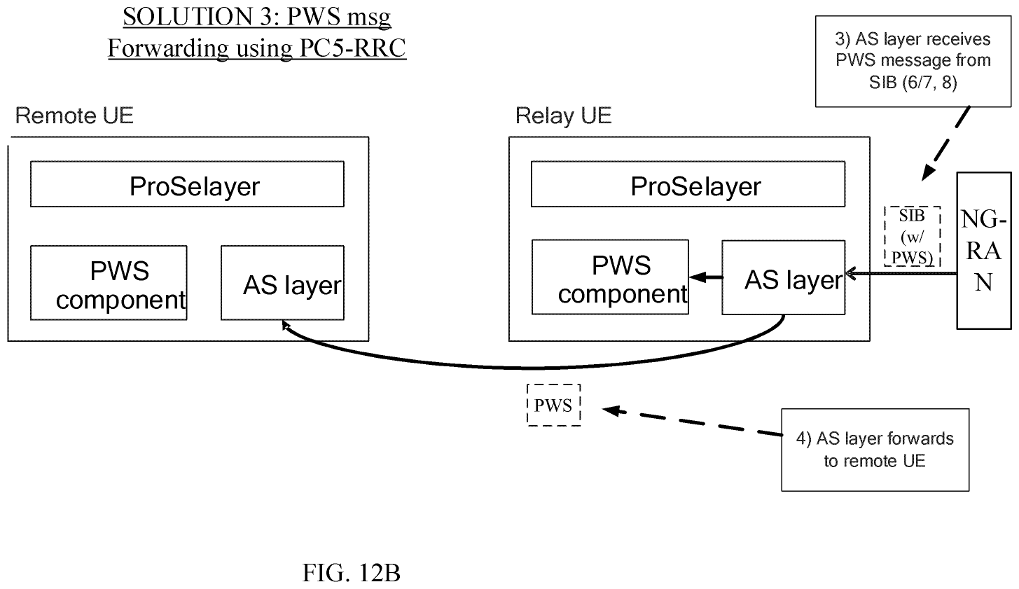

FIGS. 12A and 12B illustrate an example of relaying of PWS message to a remote UE via (Layer 3) PC5-RRC relaying (rather than the ProSe layer).

As illustrated in FIG. 12A (at step 1), the remote UE and relay UE may exchange information regarding their support of PWS relaying via PC5-RRC messaging, for example, during a Direct Link Establishment procedure or Direct Discovery procedure.

As shown as step 2, the ProSe layer may provide the AS layer with an indication of PWS forwarding, so the AS layer can know to forward PWS messages to the remote UE if received. As illustrated at step 2A, a new L2 channel can be defined and used (e.g., PC5-Relay channel).

As illustrated in FIG. 11B, once Relay UE's AS layer receives a PWS message (e.g., from SIB 6/7, 8), at step 3, the PWS message to the remote UE. In some cases, the AS may determine the target remote UE (e.g., L2 ID). The AS layer may generate a PC5-RRC message and include the PWS message received from the AS layer. The AS layer may indicate PWS forwarding in the PC5-RRC message. As noted above, the AS layer may use a new L2 channel (e.g., PC5-Relay channel) for forwarding the PWS message.

The AS layer of the remote UE may receive the PWS message and send response to Relay UE. The AS layer of the remote UE may also forward the PWS message received from the Relay UE to the PWS component.

The techniques described above, for PWS message forwarding via PC5-RRC relaying may have various benefits. For example, in case SIB forwarding is not feasible for Layer 3 UE-to-Network Relay, the PC5-RRC or a new L2 logical channel for PC5 link can be used.

Further, in some cases, forwarding via unicast can be more efficient in case of mmWave Sidelink. This is because a narrow beam may be used for mmWave to send a unicast message to a Remote UE. In contrast, in order to broadcast to Remote UE(s), the relay UE may need to send in all directions with beamforming, which would result in more power consumption, more delay, and is a relatively inefficient use of resources.

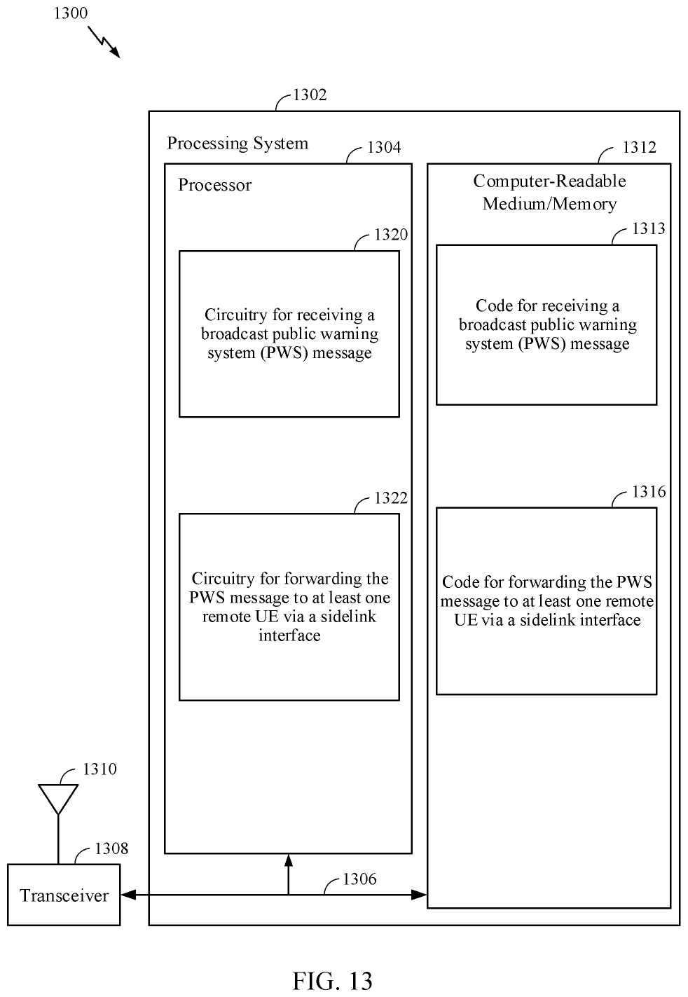

FIG. 13 illustrates a communications device 1300 that may include various components (e.g., corresponding to means-plus-function components) configured to perform operations for the techniques disclosed herein, such as the operations illustrated in FIG. 7. The communications device 1300 includes a processing system 1302 coupled to a transceiver 1308. The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 7, or other operations described herein. In certain aspects, computer-readable medium/memory 1312 stores code 1314 for receiving a broadcast public warning system (PWS) message; and code 1316 for forwarding the PWS message to at least one remote LIE via a sidelink interface. In certain aspects, the processor 1304 has circuitry configured to implement the code stored in the computer-readable medium/memory 1312. The processor 1304 includes circuitry 1320 for receiving a broadcast public warning system (PWS) message; and circuitry 1322 for forwarding the PWS message to at least one remote UE via a sidelink interface.

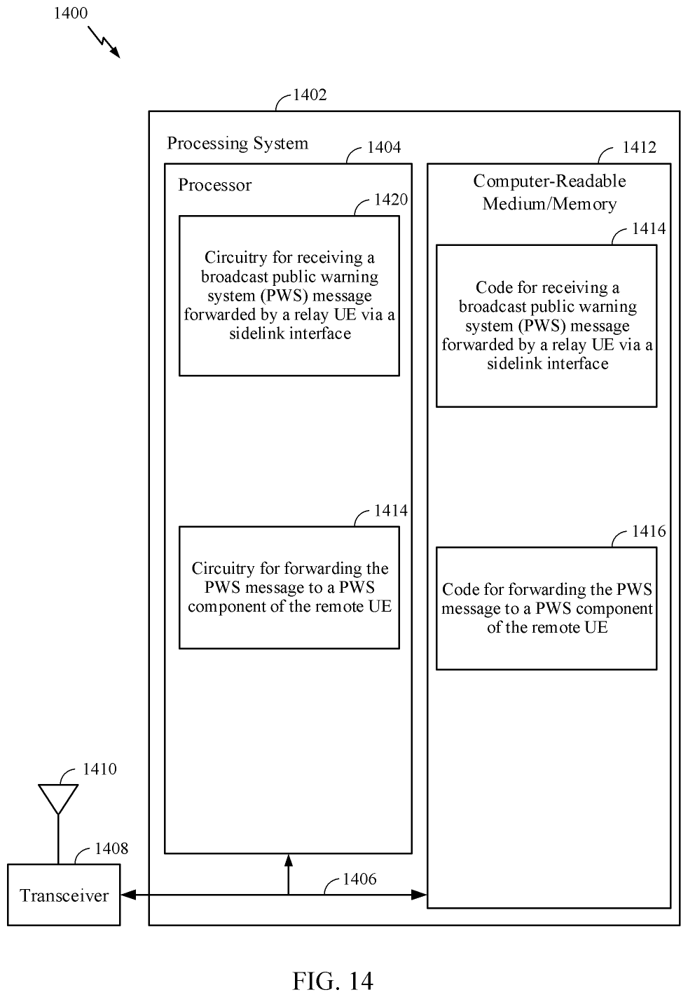

FIG. 14 illustrates a communications device 1400 that may include various components (e.g., corresponding to means-plus-function components) configured to perform operations for the techniques disclosed herein, such as the operations illustrated in FIG. 16. The communications device 1400 includes a processing system 1402 coupled to a transceiver 1408. The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes a processor 1404 coupled to a computer-readable medium/memory 1412 via a bus 1406. In certain aspects, the computer-readable medium/memory 1412 is configured to store instructions (e.g., computer-executable code) that when executed by the processor 1404, cause the processor 1404 to perform the operations illustrated in FIG. 8, or other operations described herein. In certain aspects, computer-readable medium/memory 1412 stores code 1414 for receiving a broadcast public warning system (PWS) message forwarded by a relay UE via a sidelink interface; and code 1416 for forwarding the PWS message to a PWS component of the remote UE. In certain aspects, the processor 1404 has circuitry configured to implement the code stored in the computer-readable medium/memory 1412. The processor 1404 includes circuitry 1420 for receiving a broadcast public warning system (PWS) message forwarded by a relay UE via a sidelink interface; and circuitry 1422 for forwarding the PWS message to a PWS component of the remote UE.

### Example Aspects

Aspect 1: A method for wireless communications by a relay user equipment (UE), comprising: receiving a broadcast public warning system (PWS) message; and forwarding the PWS message to at least one remote UE via a sidelink interface.

Aspect 2: The method of Aspect 1, further comprising discovering the at least one remote UE supports receiving forwarded broadcast PWS messages.

Aspect 3: The method of Aspect 2, wherein the relay UE discovers the at least one remote UE supports broadcast PWS messages via a link establishment procedure or link update procedure in which the relay UE indicates its support to forward broadcast PWS messages.

Aspect 4: The method of Aspect 2 or 3, wherein the relay UE receives a discovery message from at least one remote UE indicating the support of PWS message.

Aspect 5: The method of any of Aspects 1-4, wherein the relay UE forwards the PWS message via a unicast message.

Aspect 6: The method of any of Aspects 1-5, wherein the relay UE forwards the PWS message to a group of remote UEs via a groupcast message.

Aspect 7: The method of Aspect 6, further comprising informing the group of remote UEs of a groupcast ID used for PWS forwarding via a groupcast message.

Aspect 8: The method of any of Aspects 1-7, wherein the relay UE receives the PWS message via an access stratum (AS) layer; and forwards the PWS message to the remote UE via a proximity service (ProSe) layer.

Aspect 9: The method of Aspect 8, wherein the relay layer forwards the PWS message via the ProSe layer via: a message type dedicated to PWS forwarding or another message type with an indication the message is for PWS forwarding.

Aspect 10: The method of Aspect 8 or 9, further comprising receiving, via the ProSe layer, a response from the remote UE acknowledging receipt of the forwarded PWS message.

Aspect 11: The method of any of Aspects 8-10, wherein the AS layer receives a system information block (SIB) message containing the PWS message; the AS layer forwards the SIB message to the ProSe layer; and the ProSe layer forwards the SIB message to the remote UE.

Aspect 12: The method of Aspect 11, further comprising determining which type of SIB messages to forward to the remote UE; and forwarding only those types of SIB messages to the remote UE.

Aspect 13: The method of Aspect 11 or 12, wherein the relay layer forwards the PWS message via the ProSe layer via: a message type dedicated to SIB forwarding or another message type with an indication the message is for SIB forwarding.

Aspect 14: The method of any of Aspects 1-13, wherein the relay UE receives the PWS message via an AS layer; and forwards the PWS message to the remote UE via the AS layer.

Aspect 15: The method of Aspect 14, further comprising exchanging information regarding support for forwarding PWS messages with the remote UE, via sidelink radio resource control (RRC) signaling.

Aspect 16: The method of Aspect 14 or 15, wherein a ProSe layer of the relay UE configures the AS layer with information for forwarding the PWS message to the remote UE.

Aspect 17: The method of any of Aspects 14-16, wherein the AS layer: receives the PWS message in a SIB message; and forwards the PWS message to the remote UE via a sidelink RRC message or a relay channel.

Aspect 18: The method of any of Aspects 1-17, further comprising obtaining information regarding a location of the remote UE; obtaining location information in the PWS message; and deciding whether to forward the PWS message based on the information regarding the location of the remote UE and the location information in the PWS message.

Aspect 19: The method of Aspect 18, wherein the relay UE receives the PWS message via an AS layer; the AS layer informs a ProSe layer of location information regarding the remote UE; and the ProSe layer forwards the PWS message to the remote UE if it determines the remote UE is in a warning area covered by the PWS message.

Aspect 20: A method for wireless communications by a remote UE, comprising receiving a broadcast PWS message forwarded by a relay UE via a sidelink interface; and forwarding the PWS message to a PWS component of the remote UE.

Aspect 21: The method of Aspect 20, further comprising providing an indication, to the relay UE, that the remote UE supports receiving forwarded broadcast PWS messages.

Aspect 22: The method of Aspect 21, wherein the remote UE discovers that the relay UE supports broadcast PWS messages via a link establishment procedure or link update procedure in which the remote UE indicates its support to receive forwarded broadcast PWS messages.

Aspect 23: The method of Aspect 21 or 22, wherein the remote UE sends a discovery message indicating the support of PWS message, or wherein the remote UE receives discovery message from at least one relay UE indicating the support of PWS message forwarding.

Aspect 24: The method of any of Aspects 20-23, wherein the remote UE receives the PWS message forwarded from the relay UE via a unicast message.

Aspect 25: The method of any of Aspects 20-24, wherein the remote UE receives the PWS message forwarded from the relay UE via a groupcast message.

Aspect 26: The method of Aspect 25, further comprising receiving an indication of a groupcast ID used by the relay UE for PWS forwarding via a groupcast message.

Aspect 27: The method of any of Aspects 20-26, wherein the remote UE receives the PWS message from the relay UE via a ProSe layer.

Aspect 28: The method of Aspect 27, wherein the ProSe layer forwards the PWS message to a PWS component of the remote UE.

Aspect 29: The method of Aspect 27 or 28, further comprising sending, via the ProSe layer, a response to the relay UE acknowledging receipt of the forwarded PWS message.

Aspect 30: The method of any of Aspects 27-29, wherein the remote UE receives the PWS message in a SIB message forwarded by the relay UE.

Aspect 31: The method of Aspect 30, further comprising providing an indication, to the relay UE, of which type of SIB messages to forward to the remote UE.

Aspect 32: The method of Aspect 27, wherein the remote UE receives the PWS message via the ProSe layer via: a message type dedicated to SIB forwarding or another message type with an indication the message is for SIB forwarding.

Aspect 33: The method of any of Aspects 20-32, wherein the remote UE receives the PWS message via the AS layer.

Aspect 34: The method of Aspect 33, further comprising exchanging information regarding support for forwarding PWS messages with the relay UE, via sidelink RRC signaling.

Aspect 35: The method of Aspect 33 or 34, further comprising sending a response to the relay UE, via the AS layer, acknowledging receipt of the PWS message.

Aspect 36: The method of any of Aspects 33-35, wherein the AS layer receives the PWS message from the relay UE via a sidelink RRC message or a relay channel.

Aspect 37: An apparatus, comprising: a memory comprising executable instructions; and one or more processors configured to execute the executable instructions and cause the apparatus to perform a method in accordance with any one of Aspects 1-36.

Aspect 38: An apparatus, comprising means for performing a method in accordance with any one of Aspects 1-36.

Aspect 39: A non-transitory computer-readable medium comprising executable instructions that, when executed by one or more processors of an apparatus, cause the apparatus to perform a method in accordance with any one of Aspects 1-36.

Aspect 40: A computer program product embodied on a computer-readable storage medium comprising code for performing a method in accordance with any one of Aspects 1-36.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components. For example, various operations shown in FIGS. 7 and 8 may be performed by various processors shown in FIG. 4, such as processors 466, 458, 464, and/or controller/processor 480 of the UE 120a.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIGS. 7 and 8.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a relay user equipment (UE), comprising:
receiving a broadcast public warning system (PWS) message; and
forwarding the PWS message to at least one remote UE via a sidelink interface.

2. The method of claim 1, further comprising discovering the at least one remote UE supports receiving forwarded broadcast PWS messages.

3. The method of claim 2, wherein the relay UE discovers the at least one remote UE supports broadcast PWS messages via a link establishment procedure or link update procedure in which the relay UE indicates its support to forward broadcast PWS messages.

4. The method of claim 2, wherein the relay UE receives a discovery message from at least one remote UE indicating the support of PWS message.

5. The method of claim 1, wherein the relay UE forwards the PWS message via a unicast message.

6. The method of claim 1, wherein the relay UE forwards the PWS message to a group of remote UEs via a groupcast message.

7. The method of claim 6, further comprising informing the group of remote UEs of a groupcast ID used for PWS forwarding via a groupcast message.

8. The method of claim 1, wherein the relay UE:
receives the PWS message via an access stratum (AS) layer; and
forwards the PWS message to the remote UE via a proximity service (ProSe) layer.

9. The method of claim 8, wherein the relay layer forwards the PWS message via the ProSe layer via: a message type dedicated to PWS forwarding or another message type with an indication the message is for PWS forwarding.

10. The method of claim 8, further comprising receiving, via the ProSe layer, a response from the remote UE acknowledging receipt of the forwarded PWS message.

11. The method of claim 8, wherein:
the AS layer receives a system information block (SIB) message containing the PWS message;
the AS layer forwards the SIB message to the ProSe layer; and
the ProSe layer forwards the SIB message to the remote UE.

12. The method of claim 11, further comprising:
determining which type of SIB messages to forward to the remote UE; and
forwarding only those types of SIB messages to the remote UE.

13. The method of claim 11, wherein the relay layer forwards the PWS message via the ProSe layer via: a message type dedicated to SIB forwarding or another message type with an indication the message is for SIB forwarding.

14. The method of claim 1, wherein the relay UE:
receives the PWS message via an access stratum (AS) layer; and
forwards the PWS message to the remote UE via the AS layer.

15. The method of claim 14, further comprising exchanging information regarding support for forwarding PWS messages with the remote UE, via sidelink radio resource control (RRC) signaling.

16. The method of claim 14, wherein a proximity service (ProSe) layer of the relay UE configures the AS layer with information for forwarding the PWS message to the remote UE.

17. The method of claim 14, wherein the AS layer:
receives the PWS message in a system information block (SIB) message; and
forwards the PWS message to the remote UE via a sidelink radio resource control (RRC) message or a relay channel.

18. The method of claim 1, further comprising:
obtaining information regarding a location of the remote UE;
obtaining location information in the PWS message; and
deciding whether to forward the PWS message based on the information regarding the location of the remote UE and the location information in the PWS message.

19. The method of claim 18, wherein:
the relay UE receives the PWS message via an access stratum (AS) layer;
the AS layer informs a proximity service (ProSe) layer of location information regarding the remote UE; and
the ProSe layer forwards the PWS message to the remote UE if it determines the remote UE is in a warning area covered by the PWS message.

20. A method for wireless communications by a remote user equipment (UE), comprising:
receiving a broadcast public warning system (PWS) message forwarded by a relay UE via a sidelink interface; and
forwarding the PWS message to a PWS component of the remote UE.

21. The method of claim 20, further comprising providing an indication, to the relay UE, that the remote UE supports receiving forwarded broadcast PWS messages.

22. The method of claim 21, wherein the remote UE discovers that the relay UE supports broadcast PWS messages via a link establishment procedure or link update procedure in which the remote UE indicates its support to receive forwarded broadcast PWS messages.

23. The method of claim 21, wherein the remote UE sends a discovery message indicating the support of PWS message, or wherein the remote UE receives discovery message from at least one relay UE indicating the support of PWS message forwarding.

24. The method of claim 20, wherein the remote UE receives the PWS message forwarded from the relay UE via a unicast message.

25. The method of claim 20, wherein the remote UE receives the PWS message forwarded from the relay UE via a groupcast message.

26. The method of claim 25, further comprising receiving an indication of a groupcast ID used by the relay UE for PWS forwarding via a groupcast message.

27. The method of claim 20, wherein the remote UE:
receives the PWS message from the relay UE via a proximity service (ProSe) layer.

28-40. (canceled)

41. An apparatus for wireless communication, comprising: a memory comprising computer-executable instructions; and one or more processors configured to execute the computer-executable instructions and cause the apparatus to:
receive a broadcast public warning system (PWS) message; and
forward the PWS message to at least one remote user equipment (UE) via a sidelink interface.

42. An apparatus for wireless communication, comprising: a memory comprising computer-executable instructions; and one or more processors configured to execute the computer-executable instructions and cause the:
receive a broadcast public warning system (PWS) message forwarded by a relay UE via a sidelink interface; and
forward the PWS message to a PWS component of the remote user equipment (UE).
